(19) United States
(12) Patent Application Publication
(10) Pub. No.: US 2008/0085417 A1
(43) Pub. Date: Apr. 10, 2008

(54) Optical film coated with adhesive

(75) Inventors: Ryu Takeko, Ashiya-shi (JP); Kook Seung Shin, Niihama-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 11/898,351

(22) Filed: Sep. 11, 2007

(30) Foreign Application Priority Data
Sep. 13, 2006 (JP) 2006-247805

(51) Int. Cl. B32B 17/10; C08K 5/3432

(52) U.S. Cl. 428/441; 524/99

(57) ABSTRACT

An optical film with an adhesive layer on at least one surface of the optical film: wherein said adhesive layer is formed from a composition containing: (A) an acryl resin comprising a first acryl resin which has a structural unit derived from (meth)acrylate as a main component, and a structural unit derived from unsaturated monomer having one olefinic double bond and at least one hydroxyl group in a molecule with a weight-average molecular weight of 500,000 to 2,000,000, wherein the amount of said structural unit derived from unsaturated monomer having a hydroxyl group is 0.5 to 10 parts by weight relative to 100 parts by weight of the acryl resin;
wherein R₁ represents a hydrogen atom or a methyl group, R₂ represents an alkyl group or an aralkyl group having 1-14 carbon atoms that may be substituted by an alkoxy group having 1-10 carbon atoms, (B) an ionic compound containing a pyridinium based cation;
wherein at least one of R₃ through R₇ represents an alkyl group having 1-6 carbon atoms, the remainders each independently represent hydrogen or an alkyl group having 1-6 carbon atoms, R₆ represents an alkyl group having 1-12 carbon atoms; and (C) a crosslinker.

### 1 FIELD OF THE INVENTION

The present invention relates to an optical film coated with an adhesive. An optical film of the present invention includes, for example, a polarizing film and a phase retardation film. The present invention also relates to an optical laminate for liquid crystal display using the optical film coated with an adhesive.

### 2. BACKGROUND OF THE INVENTION

Polarizing films are equipped in a liquid crystal display device, widely used and distributed in such a form that transparent protective films are adhered to both surfaces of a polarizer, an adhesive layer is formed on a surface of at least one side of the protective films, and a separation film is laminated on the adhesive layer. Further, a phase retardation film may be laminated on a polarizing film in which protective films are laminated on both surfaces of a polarizer to provide an elliptic polarization film, an adhesive layer/separation film is on the side of the phase retardation film. Moreover, an adhesive layer/separation film may be adhered to a surface of a phase retardation film. Before being laminated on liquid crystal cells, separation films are peeled from these polarizing film, elliptic polarization film and phase retardation film, and then laminated on liquid crystal cells via the exposed adhesive layers. Since such polarizing film, elliptic polarization film or phase retardation film generates static electricity when being peeled from the separation film and laminated on liquid crystal cells, development of prevention method therefore has been desired.

As one of the methods, in Japanese Patent No. 3012860, there is proposed a method that in a polarizing film provided with an adhesive layer on a surface of a protective film which has been laminated on a surface of a polarizer film, as an adhesive, an ionic conductive composition composed of an electrolyte salt and organopolysiloxane, and a composition containing an acryl based copolymer are used. An antistatic property is exhibited by using such adhesive, but the performance is not necessarily sufficient and performance of adhesion durability is not necessarily sufficient either.

Besides, JP No. 2004-536940A discloses a method in which a pressure sensitive adhesive (adhesive) is mixed with an organic salt antistatic agent to provide the adhesive with an antistatic property. Further, JP No. 2004-114665A describes a method in which a salt composed of a quaternary ammonium cation having 4-20 carbon atoms in total and a fluorine atom-containing anion is contained in an adhesive to provide antistatic performance.

In this way, the optical film coated with an adhesive as described above is laminated on liquid crystal cells at the adhesive layer side to produce a liquid crystal display device. When this film is placed in a high temperature or high temperature and high humidity condition in this state, or when heating and cooling are repeated, in response to dimensional change of the optical film, a foam generates in the adhesive layer, or floating and peeling occur between the optical film and the adhesive layer, or between the adhesive layer and liquid crystal cell glass. Thus, preventing from such defects and excellent durability are also required. Further, in the case of exposure to high temperatures, the distribution of residual stress loaded on the optical film becomes nonuniform, resulting in stress concentration in a peripheral part of the optical film. Therefore, at display in black, a phenomenon called “white tinge” in which the peripheral part appears somewhat white takes place or irregular color takes place, hence, suppression of such white tinge and irregular color is also required. Moreover, in laminating an optical film coated with an adhesive onto liquid crystal cells, when there is a defect, the laminated optical film is peeled of f, and a new film is laminated again. A so-called re-workability is also required for being free from that, upon peeling, the adhesive layer is peeled together with the optical film to leave the adhesive on the cell glass and causing cloudiness or the like.

### SUMMARY OF THE INVENTION

It is an object of the present invention to provide an optical film coated with an adhesive in which an adhesive layer having an enhanced antistatic property and excellent durability is provided on a surface of an optical film. The present inventors have keenly studied to achieve the object and as a result, have found that by mixing an adhesive containing a specific acryl resin with a specific ionic compound, and providing this composition on a surface of an optical film as an adhesive layer, an optical film with an excellent antistatic property and durability can be obtained, and completed the present invention.

Namely, the present invention provides an optical film with an adhesive in which an adhesive layer is on at least one surface of an optical film, the adhesive layer is formed from a composition containing the following components (A), (B) and (C).

(A) an acryl resin comprising a first acryl resin which has a structural unit derived from (meth)acrylate expressed by the following formula (I) as a main component and a structural unit derived from unsaturated monomer having one olefinic double bond and at least one hydroxyl group with a weight-average molecular weight of 500,000 to 2,000.000, wherein the amount of the structural unit derived from unsaturated monomer having a hydroxyl group is 0.5 to 10 parts by weight relative to 100 parts by weight of the acryl resin; 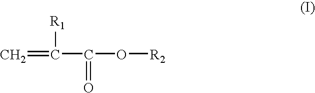
wherein R₁ represents a hydrogen atom or a methyl group, R₂ represents an alkyl group or an aralkyl group having 1-14 carbon atoms that may be substituted by an alkoxy group having 1-10 carbon atoms,

(B) an ionic compound containing a pyridinium based cation expressed by the following formula (II); 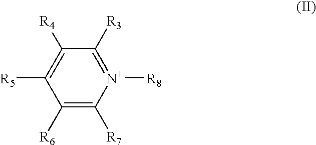
wherein at least one of R₃ through R₇ represents an alkyl group having 1-6 carbon atoms, the remainders each independently represent hydrogen or an alkyl group having 1-6 carbon atoms, R₈ represents an alkyl group having 1-12 carbon atoms; and

(C) a crosslinker.

As described above, in the present invention, it was found that when an acryl resin (A) in an adhesive has a hydroxyl group as a polar functional group, a compound containing a pyridinium based cation corresponding to the formula (II) is especially effective as an ionic compound (B) to provide an adhesive layer formed by the adhesive with an antistatic property.

The above-described acryl resin (A) may include the first acryl resin above alone, or a mixture of the first acryl resin with a different acryl resin (called a second acryl resin). The second acryl resin, for example, may include one which has a structural unit derived from (meth)acrylate expressed by the foregoing formula (I) as a main component, and a weight-average molecular weight of 50,000 to 300,000.

The present invention also provides an optical laminate wherein the optical film coated with an adhesive is laminated on a glass substrate at the adhesive layer side.

The optical film coated with an adhesive of the present invention can effectively suppress electrostatic charge of optical members. This optical film coated with an adhesive provides an optical laminate for liquid crystal display by being laminated on a glass substrate for liquid crystal cells, for example. In this optical laminate, since the adhesive layer absorbs and mitigates stress resulted from dimensional changes of the optical film and glass substrate under heat and humidity conditions, local stress concentration is mitigated, and floating and peeling of the adhesive layer from the glass substrate are prevented. Further, optical defects resulting from nonuniform stress distribution is prevented, thus, white tinge is suppressed. Moreover, after an optical film coated with an adhesive is once laminated on a glass substrate, when some sort of defect occurs, if the optical film is peeled together with the adhesive from the glass substrate, a residue of the adhesive on the surface of glass substrate after peeling and cloudiness hardly occur and the glass substrate can be used again, which lead to an excellent re-workability.

### DETAILED DESCRIPTION OF THE PREFERRED EMBODIMENTS

The present invention will be described in detail below. In the present invention, an acryl resin (A) as a resin component used for an adhesive includes a first acryl resin which has a structural unit derived from (meth)acrylate expressed by the foregoing formula (I) as a main component, and a structural unit derived from unsaturated monomer having one olefinic double bond and at least one hydroxyl group (hereinafter, sometimes called as a “hydroxyl group-containing monomer”) with a weight-average molecular weight of 500,000 to 2,000,000. The acryl resin (A) may include the first acryl resin alone, or a mixture of the first acryl resin with a different acryl resin (called a second acryl resin). The structural unit derived from hydroxyl group-containing monomer is contained at a ratio of 0.5 to 10 parts by weight in the first acryl resin relative to 100 parts by weight of the acryl resin (A). Additionally, (meth)acrylic acid means either acrylic acid or methacrylic acid, and “(meth)” in (meth)acrylate means the same when used in other cases.

In the foregoing formula (I) being a major structural unit of the first acryl resin. R₁ is a hydrogen atom or a methyl group. R₂ is an alkyl group or an aralkyl group having 1-14 carbon atoms, preferably an alkyl group. The hydrogen atom in each of the alkyl group or an aralkyl group represented by R₂ may be substituted by an alkoxy group having 1-10 carbon atoms.

The (meth)acrylate expressed by the formula (I) includes, for example, a liner alkyl acrylate such as methyl acrylate, ethyl acrylate, propyl acrylate, n-butyl acrylate, n-octyl acrylate or lauryl acrylate: a branched alkyl acrylate such as isobutyl acrylate, 2-ethylhexyl acrylate or isooctyl acrylate: a liner alkyl methacrylate such as methyl methacrylate, ethyl methacrylate, propyl methacrylate, n-butyl methacrylate, n-octyl methacrylate or lauryl methacrylate; and a branched alkyl methacrylate such as isobutyl methacrylate, 2-ethylhexyl methacrylate or isooctyl methacrylate.

In the case where R₂ is an alkyl group substituted by an alkoxy group, namely, R₂ is an alkoxyalkyl group, the (meth)acrylate expressed by the formula (X) includes, for example, 2-methoxyethyl acrylate, 2-ethoxymethyl acrylate, 2-methoxyethyl methacrylate, and 2-ethoxymethyl methacrylate. When R₂ is an aralkyl group, the (meth)acrylate expressed by the formula (I) includes, for example, benzyl acrylate and benzyl methacrylate.

In production of the first acryl resin, as the (meth)acrylate expressed by the formula (I), one kind of compound, or two or more kinds of compounds may be used. Above all, it is preferable to use butyl acrylate as at least one monomer. It is preferable that a structural unit derived from the (meth)acrylate of the first acryl resin contains a structural unit derived from a butyl acrylate.

As the hydroxyl group-containing monomer for another structural unit of the first acryl resin, a compound which has one olefinic double bond and at least one hydroxyl group in a molecule is used, and includes, for example, 2-hydroxyethyl (meth)acrylate, 2-hydroxypropyl (meth)acrylate and 4-hydroxybutyl (meth)acrylate. This hydroxyl group-containing monomer is preferably hydroxyalkyl ester of (meth)acrylic acid, in which the alkyl has about 1-10 carbon atoms, further, preferably about 2-6 carbon atoms.

Further, the first acryl resin may contain a structural unit derived from a monomer having a polar functional group other than a hydroxyl group. The polar functional group other than a hydroxyl group includes, for example, a carboxyl group, an amide group, an epoxy group, an oxetanyl group, an amino group, an isocyanate group and an aldehyde group.

The monomer in which a polar functional group is a carboxyl group includes, for example, acrylic acid, methacrylic acid, maleic acid and itaconic acid. The monomer in which a polar functional group is an amide group includes, for example, acrylamide, methacrylamide, N—(N,N-dimethylaminopropyl)acrylamide, N,N-dimethylacrylamide, N,N-diethylacrylamide, and N-methylolacrylamide. The monomer in which a polar functional group is an epoxy group includes, for example, glycidyl acrylate, glycidyl methacrylate, 3,4-epoxycyclohexyl methylacrylate, and 3,4-epoxycyclohexylmethyl methacrylate. The monomer in which a polar functional group is an oxetanyl group includes, for example, oxetanyl (meth)acrylate, 3-oxetanylmethyl (meth)acrylate, (3-methyl-3-oxetanyl)methyl (meth)acrylate, and (3-ethyl-3-oxetanyl)methyl (math)acrylate. The monomer in which a polar functional group is an amino group includes, for example, N,N-dimethylaminoethyl acrylate and allylamine. The monomer in which a polar functional group is an isocyanate group includes, for example, 2-methacryloyloxyethyl isocyanate. Further, the monomer in which a polar functional group is an aldehyde group includes, for example, acrylaldehyde. The content of the monomers containing the polar functional groups other than a hydroxyl group is preferably 30 parts by weight or less to 100 parts by weight of the hydroxyl group-containing monomer from the point of compatibility with the ionic compound (B).

In the first acryl resin, the structural unit derived from (meth)acrylate expressed by the formula (I) is generally contained in an amount of 60 to 99.5% by weight, preferably 80 to 99.5% by weight based on the weight of total nonvolatile content in the first acryl resin. Further, the hydroxyl group introduced with the unsaturated monomer is generally contained in an amount of 0-5 to 10% by weight, preferably 1 to 6% by weight. The hydroxyl group is contained in an amount of 0.5 to 10 parts by weight based on 100 parts by weight of the acryl resin (A), namely, when the acryl resin (A) is the first acryl resin alone, based on 100 parts by weight thereof, when composed of the first acryl resin and one or more acryl resin different from the first acryl resin, based on 100 parts by weight of a total of them. The ratio of the hydroxyl group to 100 parts by weight of the whole acryl resin (A) is preferably 0.5 to 6 parts by weight. When the amount of the hydroxyl group to 100 parts by weight of the acryl resin (A) is not less than 0.5 parts by weight, it is preferable because there is a tendency to suppress floating and peeling between a glass substrate and an adhesive layer when the adhesive layer containing such amount of the hydroxyl group is laminated on a glass substrate. Further, when not more than 10 parts by weight, it is preferable because even when the dimension of an optical film varies due to temperature change, the adhesive layer follows the dimensional change and varies, a difference of brightness disappears between a peripheral part of a liquid crystal cell and a center part, which tends to suppress white tinge and irregular color. Further, when the amount of the hydroxyl group to 100 parts by weight of the acryl resin (A) is the range of 0.5 to 10 parts by weight, it is preferable from the point of compatibility with an ionic compound (B) described later.

The first acryl resin may have another structural unit derived from monomer in addition to respective structural units derived from the (meth)acrylate expressed by the formula (I) and the foregoing hydroxyl group-containing monomer. Such arbitrarily usable monomer includes, for example, a heterocyclic monomer that has one olefinic double bond and at least one 5 or more membered heterocyclic group in a molecule. Herein, the 5 or more membered heterocyclic group means one in which in an aliphatic hydrocarbon group having 5 or more carbon atoms, preferably 5 to 7 carbon atoms, at least one methylene group thereof is substituted by an imino group (—NH—) or a hetero atom such as an oxygen atom or a sulfur atom.

An example of the heterocyclic monomer is acryloyl morpholine, vinyl caprolactam, N-vinyl-2-pyrrolidone, tetrahydrofurfuryl acrylate, tetrahydrofurfuryl methacrylate, and caprolactone-modified tetrahydrofurfuryl acrylate. Further, like 3,4-epoxycyclohexylmethyl acrylate and 3,4-epoxycyclohexylmethyl methacrylate, a monomer in which hetero atoms constitute a 3-membered ring and a 7-membered ring can be treated as a heterocyclic monomer because of having a 7-membered heterocyclic group. Moreover, like 2,5-dihydrofuran, an olefinic double bond may be included in a heterocyclic group. As the heterocyclic monomer, different two or more kinds of monomers may be used. As a heterocyclic monomer, above all, N-vinyl pyrrolidone, vinyl caprolactam, acryloyl morpholine or a mixture thereof is preferred.

In the case where a structural unit derived from heterocyclic monomer is contained in the first acryl resin, the amount is generally about 30% by weight or less based on the total amount of the first acryl resin, preferably 20% by weight or less. Additionally, when a structural unit derived from heterocyclic monomer is contained in the first acryl resin by 0.1 by weight or more, even when the dimension of an optical film varies, the adhesive layer follows the dimensional change and varies, a difference of brightness disappears between a peripheral part of a liquid crystal cell and a center part, which tends to suppress white tinge and irregular color.

Further, other arbitrarily usable monomer includes an alicyclic monomer which has one olefinic double bond and at least one alicyclic structure in a molecule. The alicyclic structure is a cycloparaffin structure or a cycloolefin structure generally having 5 or more carbon atoms, preferably 5 to 7 carbon atoms, and the cycloolefin structure has an olefinic double bond in an alicyclic structure. An acrylates having the alicyclic structure includes, for example, isobornyl acrylate, cyclohexyl acrylate, dicyclopentanyl acrylate, cyclododecyl acrylate, methylcyclohexyl acrylate, trimethylcyclohexyl acrylate, tert-butylcyclohexyl acrylate, cyclohexyl a-ethoxyacrylate, and cyclohexylphenyl acrylate; as methacrylate having the alicyclic structure, isobornyl methacrylate, cyclohexyl methacrylate, dicyclopentanyl methacrylate, cyclododecyl methacrylate, methylcyclohexyl methacrylate, trimethylcyclohexyl methacrylate, tert-butylcyclohexyl methacrylate, and cyclohexylphenyl methacrylate. Further, the acrylate that has a plurality of alicyclic structures in a molecule includes, biscyclohexylmethyl itaconate, dicyclooctyl itaconate and dicyclododecylmethyl succinate. Moreover, vinylcyclohexyl acetate having a vinyl group can be an alicyclic monomer. Above all, isobornyl acrylate, cyclohexyl acrylate, isobornyl methacrylate, cyclohexyl methacrylate and dicyclopentanyl acrylate are preferable because of easy availability. As alicyclic monomers, 2 or more kinds of compounds may be used in combination.

In the case where a structural unit derived from aliphatic monomer is contained in the first acryl resin, the amount is generally about 30% by weight or less based on the total amount of the first acryl resin, preferably 15% by weight or less. Additionally, when a structural unit derived from an aliphatic monomer is contained in the first acryl resin by 0.1% by weight or more, further 1% by weight or more, floating and peeling between the adhesive layer and the glass substrate tend to be suppressed.

Further, as another monomer, a vinyl monomer different from all of the (meth)acrylate expressed by the formula (I), the heterocyclic monomer and the alicyclic monomer may be used. Such vinyl monomer includes, for example, a vinyl ester of an aliphatic acid, halogenated vinyl, halogenated vinylidene, (meth)acrylonitrile, a conjugate diene compound and aromatic vinyl.

Herein, the vinyl ester of an aliphatic acid includes, for example, vinyl acetate, vinyl propionate, vinyl butyrate, vinyl 2-ethylhexanate, and vinyl laurate. The halogenated vinyl includes, for example, vinyl chloride and vinyl bromide, the halogenated vinylidene includes, for example, vinylidene chloride, and the (meth)acrylonitrile includes, for example, acrylonitrile and methacrylonitrile. The conjugate diene compound is an olefin containing conjugate double bonds in a molecule, and examples include isoprene, butadiene and chloroprene. The aromatic vinyl is a compound which has an aromatic ring and a vinyl group, and examples include styrene monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostylene, dibromostyrene, iodostyrene, nitrostyrene, acetylstyrene and methoxystyrene; and nitrogen-containing aromatic vinyl such as vinylpyridine or vinylcarbazole. These vinyl monomers may be used in combination of 2 or more kinds of compounds.

In the case where such structural unit derived from vinyl monomer is contained in the first acryl resin, the amount is generally 5% by weight or less based on the total amount of the first acryl resin, preferably 0.05% by weight or less, but it is more preferable that structural unit is not contained essentially.

Even in the case of introducing a plurality of the structural unit derived from heterocyclic monomer, the alicyclic monomer and the vinyl monomer, the total amount of them is preferably 30% by weight or less based on the total amount of the first acryl resin, further preferably 20% by weight or less.

The production method of the first acryl resin explained above includes, for example, a solution polymerization method, an emulsion polymerization method, a bulk polymerization method and a suspension polymerization method, and among these, the solution polymerization method is preferred. An example of the solution polymerization method includes, a method in which desired monomers and an organic solvent are mixed, the mixture is adjusted for the monomer concentration to be 50% by weight or more, preferably 50 to 60% by weight, put under a nitrogen atmosphere, a polymerization initiator is added by about 0.001 to 5 parts by weight relative to 100 parts by weight of total amount of monomers, stirred at about 40 to 90° C., preferably about 50 to 70° C., for 8 hours or more, preferably about 8 to 12 hours.

As the polymerization initiator, a thermal polymerization initiator and a photo polymerization initiator are used. The photo polymerization initiator includes, for example, 4-(2-hydroxyethoxy)phenyl(2-hydroxy-2-proyl)ketone. As the thermal polymerization initiator includes, for example, ago compounds such as 2,2′-azobisisbutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate) and 2,2′-azobis(2-hydroxymethylpropionitrile); organic peroxides such as lauryl peroxide, tert-butyl hydroperoxide, benzoyl peroxide, tert-butylperoxy benzoate, cumene hydroperoxide, diisopropylperoxy carbonate, di-n-propylperoxy dicarbonate, tert-butylperoxy neodecanoate, tert-butylperoxy pivalate, and (3,5,5-trimethylhaxanonyl)peroxide; and inorganic peroxides such as potassium persulfate, ammonium persulfate and hydrogen peroxide. Further, a redox type initiator in concomitant use of a peroxide and a reducing agent can be used as a polymerization initiator.

The organic solvent used in the polymerization reaction includes, for example, aromatic hydrocarbons such as toluene and xylene; esters such as ethyl acetate and butyl acetate; aliphatic alcohols such as n-propyl alcohol and isopropyl alcohol; and ketones such as acetone, methyl ethyl ketone, and methyl isobutyl ketone.

The molecular weight of the first acryl resin is a range of 500,000 to 2.000,000 in a weight-average molecular weight (Mw) based on a polystyrene calibration standard by gel permeation chromatography (GPC). When the weight-average molecular weight is 500,000 or more, it is preferable because adhesion is improved under high temperature and high humidity, and there is a tendency that the probability of occurrence of floating and peeling between a glass substrate and an adhesive layer is lowered, and also a tendency that re-workability is improved. Further, when the weight-average molecular weight is 2,000,000 or less, it is preferable because even when the dimension of an optical film laminated on an adhesive layer varies due to temperature change, the adhesive layer follows the dimensional change and varies, a difference of brightness disappears between a peripheral part of a liquid crystal cell and a center part, which tends to suppress white tinge and irregular color. The molecular weight distribution expressed by a ratio (Mw/Mn) of a weight-average molecular weight (Mw) to a number-average molecular weight (Mn) is generally in a range of about 2 to 10.

The adhesive used in the present invention may contain, as an acryl resin (A), a second acryl resin different from the above-described first acryl resin. The second acryl resin that can be used additionally includes, for example, a low molecular one which has a structural unit derived from (meth)acrylate expressed by the formula (I) as a main component and a weight-average molecular weight (Mw) in a range of about 50,000 to 300,000 based on a polystyrene calibration standard by GPC.

In the case where the second acryl resin with a low molecular weight is used, the amount is usually 5 to 50 parts by weight relative to 100 parts by weight of total amount of nonvolatile content of the acryl resin (A), preferably about 10 to 40 parts by weight. When the amount of the second acryl resin is 5 parts by weight or more to 100 parts by weight of total amount of nonvolatile content of the acryl resin (A), it is preferable because even when the dimension of an optical film varies, the adhesive layer follows the dimensional change and varies, a difference of brightness disappears between a peripheral part of a liquid crystal cell and a center part, which tends to suppress white tinge and irregular color, and when the amount of the second acryl resin is 50 parts by weight or less, it is preferable because adhesion is improved under high temperature and high humidity, and there is a tendency to lower the probability of occurrence of floating and peeling between a glass substrate and an adhesive layer, and also a tendency to improve re-workability.

Regarding the acryl resin (A) used as an adhesive, in the case of using the acryl resin alone, i.e., the first acryl resin alone, it is the acryl resin itself, or in the case of using by mixing the first acryl resin with the second acryl resin, it is the mixture; when it is dissolved in ethyl acetate to prepare a solution with a concentration of the nonvolatile content to be 20% by weight, the viscosity of the solution is preferably 10 Pa·s or less at 25° C., further preferably 0.1 to 7 Pa·s. When this viscosity is 10 Pa·s or less, it is preferable because adhesion is improved under high temperature and high humidity, and there is a tendency to lower the probability of occurrence of floating and peeling between a glass substrate and an adhesive layer, and also a tendency to improve re-workability. The viscosity can also be measured by a Brookfield viscometer.

In the present invention, in addition to the acryl resin (A) described above, an ionic compound (B) is used. This ionic compound (B) contains a pyridinium based cation expressed by the foregoing formula (II). In the formula (II), R₃ through R₇ bonded to a carbon atom constituting a pyridine ring represent each independently a hydrogen atom or an alkyl group having 1-6 carbon atoms, and at least one of these represents an alkyl group having 1-6 carbon atoms, and R₈ represents an alkyl group having 1-12 carbon atoms. This ionic compound (B) is advantageous because it is a liquid at ordinary temperature (about 23° C.). The pyridinium based cation expressed by the formula (II) has 8 or more carbon atoms in total, further preferably 10 or more carbon atoms and particularly preferably 12 or more carbon atoms from the point of compatibility with the acryl resin (A). Further, the number of total carbon atoms is preferably 36 or less, further preferably 30 or less. Of the pyridinium based cations expressed by the formula (II), one of preferable cations is one in which R₅ bonding to a 4-position carbon atom of a pyridine ring is an alkyl group and R₃, R₄, R₆ and R₈ are each a hydrogen atom.

An example of the pyridinium based cation expressed by the formula (II) includes, for example, the following ones.

N-methyl-4-hexyl pyridinium cation, N-butyl-4-butyl pyridinium cation, N-butyl-2,4-diethyl pyridinium cation, N-butyl-2-hexyl pyridinium cation, N-hexyl-2-butyl pyridinium cation, N-hexyl-4-methylpyridinium cation, N-hexyl-4-ethyl pyridinium cation, and N-hexyl-4-butyl pyridinium cation.

On the other hand, an anion component of an ionic compound (B) is preferably one satisfying that it becomes an ionic liquid, and it is not particularly limited any more. For example, following ones can be listed.

Chloride anion [Cl⁻], bromide anion [Br⁻], iodide anion [I⁻], tetrachloroaluminate anion [AlCl₄⁻], heptachlorodialuminate anion [Al₂Cl₇⁻], terafluoroborate anion [BF₄⁻], hexafluorophosphate anion [PF₆⁻], perchlororate anion [ClO₄⁻], nitrate anion [NO₃⁻], acetate anion [CH₃COO⁻], trifluoroacetate anion [CF₃COO⁻], methanesulfonate anion [CH₃SO₃⁻], trifluoromethanesulfonate anion [CF₃SO₃⁻], bis(trifluoromethanesulfonyl)imide anion [(CF₃SO₂)₂N⁻], tris(trifluoromethanesulfonyl)methanide anion [(CF₃SO₂)₃C⁻], hexafluoroarcenate anion [AsF₆⁻], hexafluoroantimonate anion [SbF₆⁻], hexafluoroniobate anion [NbF₆⁻], hexafluorotantalate anion [TaF₆⁻], (poly)hydrofluorofluoride anion [F(HF)n⁻] (n is about 1 to 3), dicyanamide anion [(CN)₂N⁻], perfluorobutanesulfonate anion [C₄F₉SO₃⁻], bis(pentafluoroethanesulfonyl)imide anion [(C₂F₅SO₂)₂N⁻], perfluorobuthanoate anion [C₃F₇COO⁻], and (trifluoromethanesulfonyl)(trifluoromethanecarbonyl) imid e anion [(CF₃SO₂)(CF₃CO)N⁻].

Of these, in particular, an anion component containing a fluorine atom is preferably used because an ionic compound with low melting point is obtained, and above all, bis(trifluoromethanesulfonyl)imide anion and hexafluorophosphate anion are preferred.

Examples of the ionic compound used in the present invention may be suitably selected from a combination of the above-described cation component and the anion component. A compound of the combination of the cation component and the anion component includes, for example, following ones.

N-methyl-4-hexyl pyridinium bis(trifluoromethanesulfonyl)imide, N-butyl-2-hexyl pyridinium bis(trifluoromethanesulfonyl)imide. N-hexyl-4-methylpyridinium bis(trifluoromethanesulfonyl) imide, N-methyl-4-hexyl pyridinium hexafluorophosphate, N-butyl-2-hexyl pyridinium hexafluorophosphate, N-hexyl-4-methylpyridinium hexafluorophosphate, N-methyl-4-hexyl pyridinium perchlorate, N-butyl-2-hexyl pyridinium perchlorate, and N-hexyl-4-methyl pyridinium perchlorate.

The ionic compound (B) containing the pyridinium based cation expressed by the formula (II), as described above, is effective for providing an adhesive layer formed by a composition containing an acryl resin (A) having a hydroxyl group as a polar functional group with an antistatic property and maintaining various physical properties as an adhesive. The ionic compound (B) is contained preferably in a ratio of about 0.1 to 10 parts by weight relative to 100 parts by weight of nonvolatile content of the acryl resin (A), preferably in a ratio of 0.2 to 3 parts by weight, further preferably in a ratio of 0.3 to 1.5 parts by weight. When the ionic compound (B) is contained in a ratio of 0.1 parts by weight or more to 100 parts by weight of nonvolatile content of the acryl resin (A), it is preferable because an antistatic property is improved, and when 10 parts by weight or less, it is preferable because the ionic compound (B) hardly bleeds out.

An adhesive composition is prepared by further mixed with a crosslinker (C) in the acryl resin (A) and the ionic compound (B) described above. The crosslinker (C) is a compound which has at least two functional groups in a molecule crosslinkable with the structural unit derived from hydroxyl group-containing monomer in the acryl resin (A), particularly in the first acryl resin, and the example includes an isocyanate based compound, an epoxy based compound, a metal chelate based compound and an aziridine based compound.

The isocyanate based compound is a compound which has at least two isocyanate groups (—NCO) in a molecule, for example, it includes tolylene diisocyanate, hexamethylene diisocyanate, isophorone diisocyanate, xylene diisocyanate, hydrogenated xylene diisocyanate, diphenylmethane diisocyanate, hydrogenated diphenylmethane diisocyanate, naphthalene diisocyanate, and triphenylmethane triisocyanate. Further, adducts in which polyols such as glycerol and trimethylolpropane are reacted with these isocyanate compounds, and a dimer and a trimer made of isocyanate compounds are usable in adhesives as a crosslinker. Two or more kinds of isocyanate based compounds can be mixed and used.

The epoxy based compound is a compound which has at least two epoxy groups in a molecule, and for example, it includes a bisphenol-A type epoxy resin, ethyleneglycol diglycidyl ether, polyethyleneglycol diglycidyl ether, glycerin diglycidyl ether, glycerin triglycidyl ether, 1,6-hexanediolglycidyl ether, trimethylolpropane triglycidyl ether, N,N-diglycidylaniline, N,N,N′,N′-tetraglycidyl-m-xylenediamine, and 1,3-bis(N,N′-diglycidylaminomethyl)cyclohexane. Two or more epoxy based compounds can be mixed and used.

The metal chelate compound includes, for example, one in which acetyl acetone or ethyl acetoacetate is coordinated to multivalent metals such as aluminum, iron, copper, zinc, tin, titanium, nickel, antimony, magnesium, vanadium, chromium and zirconium.

The aziridine based compound is a compound which has at least two 3-membered ring skeletons composed of one nitrogen atom and two carbon atoms, also called ethyleneimine, in a molecule, and for example, It includes diphenylmethane-4,4′-bis(1-aziridinecarboxamide), toluene-2,4-bis(1-aziridinecarboxamide), triethylenemelamine, isophthaloylbis-1-(2-methylaziridine), tris-1-aziridinylphosphin oxide, hexamethylene-1,6-bis(1-aziridinecarboxamide), trimethylolpropane-tri-β-aziridinyl propionate, and tetramethylolmethane-tri-β-aziridinyl propionate.

Among these crosslinkers, preferably used are the isocyanate based compounds, above all, xylene diisocyanate or tolylene diisocyanate, or adducts in which polyols such as glycerol and trimethylolpropane are reacted with these isocyanate compounds, a mixture of a dimer and a trimer made of isocyanate compounds, and a mixture of these isocyanate based compounds. A preferable isocyanate based compounds includes, for example, tolylene diisocyanate, or adducts in which polyols are reacted with tolylene diisocyanate, a dimer of tolylene diisocyanate, and a trimer of tolylene diisocyanate.

The crosslinker (C) is mixed generally in a ratio of about 0.01 to 10 parts by weight relative to 100 parts by weight of the acryl resin (A), preferably about 0.1 to 7 parts by weight, further preferably about 0.3 to 1.5 parts by weight. When the amount of the crosslinker (C) to 0.01 parts by weight or more of 100 parts by weight of the acryl resin (A), it is preferable because there is a tendency to improve durability of the adhesive layer, and when 10 parts by weight or less, it is preferable because white tinge becomes unnoticeable when an optical film coated with an adhesive is applied to a liquid crystal display device.

As the adhesive for forming an adhesive layer of the present invention, in order to improve adhesion of the adhesive layer to a glass substrate, it is preferable to contain a silane based compound, in particular, it is preferable to contain a silane based compound in an acryl resin before compounding a crosslinker.

The silane based compound includes, for example, vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-menthacryloxypropyltrimethoxysilane, 3-mercaptopropyltrimethoxysilane, 3-glycidoxypropyltrimethoxysilane, 3-glycidoxypropyltriethoxysilane, 3-glycidoxypropyldimethoxymethylsilane, and 3-glycidoxypropylethoxydimethylsilane. Two or more kinds of silane based compounds may be mixed and used.

Silane based compounds may be a silicone oligomer type. When a silicone oligomer is expressed as a (monomer)oligomer form, for example, it includes the followings.

Copolymers containing a mercaptopropyl group such as: 3-mercaptopropyltrimethoxysilane-tetramethoxysilane copolymer, 3-mercaptopropyltrimethoxysilane-tetraethoxysilane copolymer, 3-mercaptopropyltriethoxysilane-tetramethoxysilane copolymer, and 3-mercaptopropyltriethoxysilane-tetraethoxysilane copolymer;

copolymers containing a mercaptomethyl group such as: mercaptomethyltrimethoxysilane-tetramethoxysilane copolymer, mercaptomethyltrimethoxysilane-tetraethoxysilane copolymer, mercaptomethyltriethoxysilane-tetramethoxysilane copolymer, and mercaptomethyltriethoxysilane-tetraethoxysilane copolymer;

copolymers containing an methacryloyloxypropyl group such as: 3-methacryloyloxypropyltrimethoxysilane-tetramethoxysilane copolymer, 3-methacryloyloxypropyltrimethoxysilane-tetraethoxysilane copolymer, 3-methacryloyloxypropyltriethoxysilane-tetramethoxysilane copolymer, 3-methacryloyloxypropyltriethoxysilane-tetraethoxysilane copolymer, 3-methacryloyloxypropylmethyldlmethoxysilane-tetramethoxysi lane copolymer, 3-methacryloyloxypropylmethyldimethoxysilane-tetraethoxysilane copolymer, 3-methacryloyloxypropylmethyldiethoxysilane-tetramethoxysilane copolymer, and 3-methacryloyloxypropylmethyldiethoxysilane-tetraethoxysilane copolymer;

copolymers containing an acryloyloxypropyl group such as: 3-acryloyloxypropyltrimethoxysilane-tetramethoxysilane copolymer, 3-acryloyloxypropyltrimethoxysilane-tetraethoxysilane copolymer, 3-acryloyloxypropyltriethoxysilane-tetramethoxysilane copolymer, 3-acryloyloxypropyltriethoxysilane-tetraethoxysilane copolymer, 3-acryloyloxypropylmethyldimethoxysilane-tetramethoxysilane copolymer, 3-acryloyloxypropylmethyldimethoxysilane-tetraethoxysilane copolymer, 3-acryloyloxypropylmethyldiethoxysilane-tetramethoxysilane copolymer, and 3-acryloyloxypropylmethyldiethoxysilane-tetraethoxysilane copolymer:

copolymers containing a vinyl group such as: vinyltrimethoxysilane-tetramethoxysilane copolymer, vinyltrimethoxysilane-tetraethoxysilane copolymer, vinyltriethoxysilane-tetramethoxysilane copolymer, vinyltriethoxysilane-tetraethoxysilane copolymer, vinylmethyldimethoxysilane-tetramethoxysilane copolymer, vinylmethyldimethoxysilane-tetraethoxysilane copolymer, vinylmethyldiethoxysilane-tetramethoxysilane copolymer, andvinylmethyldiethoxysilane-tetraethoxysilane copolymer;

copolymers containing an amino group such as: 3-aminoproypyltrimethoxysilane-tetramethoxysilane copolymer, 3-aminoproypyltrimethoxysilane-tetraethoxysilane copolymer, 3-aminoproypyltriethoxysilane-tetramethoxysilane copolymer, 3-aminoproypyltriethoxysilane-tetraethoxysilane copolymer, 3-aminoproypylmethyldimethoxysilane-tetramethoxysilane copolymer, 3-aminoproypylmethyldimethoxysilane-tetraethoxysilane copolymer, 3-aminoproypylmethyldiethoxysilane-tetramethoxysilane copolymer, and 3-aminoproypylmethyldiethoxysilane-tetraethoxysilane copolymer.

These silane based compounds are liquids in many cases. The amount of the silane based compound contained in an adhesive is generally about 0.0001 to 10 parts by weight relative to 100 parts by weight of nonvolatile content of the acryl resin (A) (in the case of using 2 or more kinds, the total weight), preferably in the ratio of 0-01 to 5 parts by weight. When the amount of the silane based compound relative to 100 parts by weight of nonvolatile content of the acryl resin is 0.0001 parts by weight or more, It is preferable because adhesion of the adhesive layer to a glass substrate is improved. Further, when the amount is 10 parts by weight or less, it is preferable because bleed-out of silane based compounds from the adhesive layer tends to be suppressed.

To the adhesive explained above, further, there may be added a crosslink catalyst, a weather stabilizer, a tackifier, a plasticizer, a softener, a dye, a pigment and an inorganic filler. In particular, when a crosslink catalyst is mixed in an adhesive together with a crosslinker, an adhesive layer can be prepared by curing in short time, and in the resultant optical film coated with an adhesive, the occurrence of floating and peeling between the optical film and adhesive layer, and foaming in the adhesive layer can be suppressed, leading to better re-workability sometimes. The crosslink catalyst includes, for example, amine based compounds such as hexamethylenediamine, ethylenediamine, polyethyleneimine, hexamathylenetetramine, diethylenetriamine, triethylenetetramine, isophoronediamine, trimethylenediamine, a polyamino resin and a melamine resin. In the case where amine based compounds are compounded in adhesives as a crosslink catalyst, isocyanate based compounds are preferred as a crosslinker.

The optical film used in the optical film coated with an adhesive of the present invention is a film with optical properties, and includes, for example, a polarizing film and a phase retardation film.

The polarizing film is an optical film with a function radiating polarized light to incident light like natural light. In polarizing films, there are: a liner polarizing film having a property that it absorbs a liner polarized light with a vibrating plane in a certain direction and transmits a liner polarized light with a vibrating plane perpendicular thereto; a polarized light-separating film having a property that it reflects a liner polarized light with a vibrating plane in a certain direction and transmits a liner polarized light with a vibrating plane perpendicular thereto; and an elliptic polarization film in which a polarizing film is laminated with a phase retardation film explained later. Regarding polarizing films, particularly a liner polarizing film (sometimes called a polarizer, or a polarizer film), a suitable example includes one in which a uniaxially stretched polyvinyl alcohol resin film on/in which iodine is adsorbed/oriented or a dichromatic pigment like a dichromatic dye.

The phase retardation film is an optical film showing optical anisotropy, and includes, for example, a stretched film obtained by stretching about 1.01 to 6 times a film of a polymer such as polyvinyl alcohol, polycarbonate, polyester, polyarylate, polyimide, polyolefin, cyclic polyolefin, polystyrene, polysulfone, polyether sulfone, polyvinylidenefluoride/polymethylmethacrylate, liquid crystalline polyester, acetyl cellulose, saponified ethylene-vinyl acetate copolymer, or polyvinyl chloride. Among these, a polymer film in which a polycarbonate film or a cyclic polyolefin film is stretched uniaxially or biaxially is preferred. There are so-called uniaxial phase retardation film, wide view angle phase retardation film and low optical elasticity-phase retardation film, and any one can be applied.

Further, a film with optical anisotropy developed by coating/orienting a liquid crystalline compound and a film with optical anisotropy developed by coating an Inorganic layer compound can also be used as a phase retardation film. In such phase retardation films, there are so-called temperature-compensated phase retardation film, “LC film” (trade name, manufactured by Nippon Oil Corporation; a rod-like liquid crystal-twist orientation film), “NH film” (trade name, manufactured by Nippon Oil Corporation; a rod like liquid crystal-tilt orientation film), “WV film” (trade name, manufactured by Fuji Photo Film Co., Ltd.; a disk like liquid crystal-tilt orientation film), “VAC film” (trade name, manufactured by Sumitomo Chemical Co., Ltd.; a completely biaxially stretched film), and “new VA film” (trade name, manufactured by Sumitomo Chemical Co., Ltd.; a biaxially stretched film).

Further, a film with the protective film laminated on such optical film can be used as an optical film. As the protective film, a transparent resin film is used, and the transparent resin includes, for example, acetyl cellulose based resins typified by triacetyl cellulose and diacetyl cellulose, methacrylate resins typified by polymethylmethacrylate, polyester resins, polyolefin based resins, polycarbonate resins, polyetheretherketone resins, and polysulfone resins. Resins for the protective film may be compounded with an ultraviolet absorber such as a salicylate based compound, a benzophenone based compound, a benzotriazole based compound, a triazine based compound, a cyanoacrylate based compound and a nickel complex salt based compound. As the protective film, a film of acetyl cellulose based resin like triacetyl cellulose is preferably used.

Among the optical films explained above, a liner polarizing film is often used in a state in which a protective film is laminated on one surface or both surfaces of a polarizer such as a film of a polyvinyl alcohol resins of which the linear polarizing film is composed. Further, the aforementioned elliptic polarization film is one in which a linear polarizing film is laminated with a phase retardation film, and such polarizing film is often used in a state in which a protective film is laminated on one surface or both surfaces of a polarizer film. In the case where the adhesive layer of the present invention is formed on such elliptic polarization film, generally, the adhesive layer is formed on the phase retardation film side.

The optical film coated with an adhesive of the present invention can be laminated on a glass plate at the adhesive layer to produce an optical laminate. Herein, the glass substrate includes, for example, a glass substrate for a liquid crystal cell, anti-glare glass and glass for sunglasses. In particular, such optical laminate is preferable because it can be used as a liquid crystal display device, that an optical film coated with an adhesive (upper polarizing film) is laminated on a glass substrate at a front side (visible side) of a liquid crystal cell, and another optical film coated with an adhesive (lower polarizing film) is laminated on a glass substrate at the rear side of liquid crystal cell. Materials of the glass substrate includes, for example, soda lime glass, low-alkali glass and alkali-free glass.

The optical film coated with an adhesive can be produced by a method in which an adhesive is laminated on a separation film and an optical film is further laminated on the resultant adhesive layer, and a method in which an adhesive is laminated on an optical film, a separation film is laminated on the adhesive surface for protection to produce an optical film coated with an adhesive. Herein, the separation film includes, for example, one in which a film of various kinds of resins such as polyethylene terephthalate, polybutylene terephthalate, polycarbonate and polyarylate is used as a substrate, and a contact surface to an adhesive layer of this substrate is subjected to a separation treatment like silicone treatment. To produce an optical laminate by laminating the optical film coated with an adhesive onto a glass substrate, for example, a separation film may be peeled from the optical film coated with an adhesive obtained as described above, and the exposed adhesive layer may be laminated on a surface of a glass substrate.

The optical film coated with an adhesive of the present invention is laminated on a glass substrate to produce an optical laminate, and when some sort of defect occurs after that and the optical film is peeled from the glass substrate, the adhesive layer is not peeled together with the optical film, and cloudiness and a residue of the adhesive hardly occur on the surface that has contacted the adhesive layer, thus, an optical film coated with an adhesive is easily laminated again on the glass substrate after separation. Namely, the film is excellent in so-called re-workability.

The liquid crystal display device formed from the optical laminate of the present invention can be used in, for example, a liquid crystal display for a personal computer including laptop, desk top and PDA (Personal Digital Assistance), television, a display in vehicle, an electronic dictionary, a digital camera, a digital video camera, an electronic desk calculator and a watch.

### EXAMPLES

The present invention is described further specifically with reference to Examples below, but the present invention is not limited to these examples. In the examples, “part” and “%” for expressing use-amount or content is based on weight unless otherwise noted.

In the following examples, the nonvolatile content is a value measured in accordance with JIS K 5407. Specifically, an adhesive solution was sampled in a petri dish by an arbitrary weight, dried in an explosion-proof oven at 115° C. for 2 hours, and the weight of the residual nonvolatile content is expressed as a ratio to the weight of the solution first sampled. Further, the measurement of weight-average molecular weight was conducted as follows; to a GPC equipment were connected 2 columns of “TSK gel GM_{HR}-H(S)” in series as a column (manufactured by Tohso Corporation), tetrahydrofuran was used as an eluate, in the conditions of sample concentration: 5 mg/ml, amount of sample injected: 100 μl, temperature: 40° C., flow rate: 1 ml/min, and expressed based on a polystyrene calibration standard.

First, there will be shown examples in which a first acryl resin with a high molecular weight specified by the present invention and an acryl resin with a high molecular weight for comparison having no structural unit derived from hydroxyl group-containing monomer were produced.

### Polymerization Example 1

In a reactor equipped with a condenser, a nitrogen-introducing tube, a thermometer and a stirrer was charged a mixed solution of 81.8 parts of ethyl acetate, 99.0 parts of butyl acrylate and 1.0 part of 4-hydroxybutyl acrylate, and the internal temperature was raised to 55° C. while replacing air within the equipment by a nitrogen gas to eliminate oxygen. Thereafter, a solution in which 0.14 parts of azobisbutyronitrile (polymerization initiator) dissolved in 10 parts of ethyl acetate was wholly added. After 1 hour from the addition of the initiator, while continuously adding ethyl acetate into the reactor for the concentration of acryl resin except a monomer so as to be 35% at a feed speed of 17. 3 parts/hr, the internal temperature was maintained at 54 to 56° C. for 12 hours, and lastly ethyl acetate was added to adjust the concentration of the acryl resin to 20%. The acryl resin obtained had a weight-average molecular weight of 1,790,000 based on a polystyrene calibration standard by GPC and Mw/Mn of 5.5. This is referred to as an acryl resin A1. The structural unit derived from 4-hydroxybutyl acrylate being a hydroxyl group-containing monomer in the acryl resin A1 is 1%.

### Polymerization Example 2

An acryl resin solution was obtained in the same manner as in Polymerization Example 1 except that monomer composition was changed to 98.8 parts of butyl acrylate, 1.0 part of 2-hydroxyethyl acrylate and 0.2 parts of acrylic acid. The acryl resin obtained had a weight-average molecular weight of 1,470,000 based on a polystyrene calibration standard by GPC and Mw/Mn of 4.2. This is referred to as an acryl resin A2. The structural unit derived from 2-hydroxyethyl acrylate being a hydroxyl group-containing monomer in the acryl resin A2 is 1%, and the structural unit derived from acrylic acid being a carboxyl group-containing monomer is 0.2%.

### Polymerization Example 3

### Production of Resin for Comparison

An acryl resin solution was obtained in the same manner as in Polymerization Example 1 except that monomer composition was changed to 98.9 parts of butyl acrylate and 1.1 parts of acrylic acid. The acryl resin obtained had a weight-average molecular weight of 1,670,000 based on a polystyrene calibration standard by GPC and Mw/Mn of 4.4. This is referred to as an acryl resin A3. The structural unit derived from acrylic acid being a carboxyl group-containing monomer in the acryl resin A3 is 1.1%, and this resin does not contain the structural unit derived from a hydroxyl group-containing monomer.

Next, an example in which a second acryl resin with a low molecular weight was produced is shown.

### Polymerization Example 4

In the reactor used in Polymerization Example 1 were charged 222 parts of ethyl acetate, 35 parts of butyl acrylate, 44 parts of butyl methacrylate, 20 parts of methyl acrylate and 1 part of 2-hydroxyethyl acrylate, after replacing air in the reactor by a nitrogen gas, the internal temperature was raised to 75° C. After a solution of 0.55 parts of azobisisobutyronitrile (polymerization initiator) dissolved in 12.5 parts of ethyl acetate was totally added thereto, while the internal temperature was maintained at 69 to 71° C. for 8 hours, reaction was completed. The acryl resin obtained had a weight-average molecular weight of 90,000 based on a polystyrene calibration standard by GPC. This is referred to as an acryl resin A4.

Next, there will be shown Examples and Comparative Examples in which adhesives were prepared by using the acryl resins produced above and applied to optical films. In the examples below, the following ionic compounds were used. Symbol of respective compounds is given for later reference. Any compound was liquid at ordinary temperature. Compound 1: N-hexyl-4-methylpyridinium bis(trifluoromethanesulfonyl)imide (having the following structure) 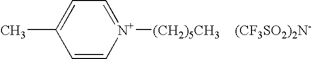
Compound 2: N-hexyl-4-methylpyridinium hexafluorophosphate (having the following structure) 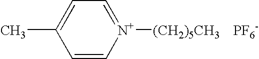
Compound 3: Trioctylmethylammonium bis(trifluoromethanesulfonyl)imide (having the following structure)

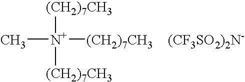

Further, as a crosslinker and a silane compound, the following respective materials were used (all of them are trade names).

Crosslinker:

Colonate L: an ethyl acetate solution of an adduct of tolylene diisocyanate with trimethylolpropane (solid content concentration 75%), obtained from Nippon Polyurethane Industry Co., Ltd., this compound is abbreviated as “Cor-L” in Table 1 below.

Takenate D110N: an ethyl acetate solution of an adduct of xylene diisocyanate with trimethylolpropane (solid content concentration 75%), obtained from Mitsui Chemicals Polyurethanes Inc., this compound is abbreviated as “D110N” in Table 1 below.

TAZM: trimethylolpropane-tri-β-aziridinyl propionate Silane compound;

X-41-1805: a silane oligomer having a mercapto group (liquid), obtained from Shin-Etsu Chemical Co., Ltd.

### Examples 1 to 3 and Comparative Examples 1 to 4

### (a) Production of Adhesive

Ethyl acetate solutions were prepared from the acryl resin A1 itself obtained in Polymerization Example 1 or the acryl resin A2 Itself obtained in Polymerization Example 2, or a mixture of the acryl resin A3 obtained in Polymerization Example 3 with the acryl resin A4 obtained in Polymerization Example 4 in the weight ratio of nonvolatile content shown in Table 1. With 100 parts of nonvolatile content of the thus obtained solution, each of the ionic compounds 1 to 3, crosslinkers “Colonate L”, Takenate D110N” and “TAZM” and the silane compound “X-41-1605” was mixed in each ratio shown in Table 1 to prepare an adhesive composition. Here, in Table 1, the mixed amount (part) of the crosslinker “Colonate L” or Takenate D110N” is the amount of solid content.

TABLE 1

| | High molecular | Low | | | |
|---|---|---|---|---|---|
| | weight Acryl resin | molecular | | | Silane |
| | Kind/Amount | weight | Ionic | | compound |
| | (monomer | Acryl resin | compound | Crosslinker | X-41-1805 |
| | composition*) | Kind/Amount | Kind/Amount | Kind/Amount | Kind/Amount |
| Example 1 | A1/100 parts | — | Compound 1/ | Cor-L/0.3 parts | 0.1 parts |
| | (BA/4-HBA) | | 3.0 parts | | |
| Example 2 | A2/100 parts | — | Compound 1/ | Cor-L/0.55 parts | 0.1 parts |
| | (BA/2-HEA/AA) | | 2.5 parts | | |
| Example 3 | A2/100 parts | — | Compound 2/ | Cor-L/0.6 parts | 0.1 parts |
| | (BA/2-HEA/AA) | | 2.5 parts | | |
| Comparative | A1/100 parts | — | — | D110N/0.13 parts | 0.1 parts |
| Example 1 | (BA/4-HBA) | | | | |
| Comparative | A1/100 parts | — | Compound 3/ | D110N/0.3 parts | 0.1 parts |
| Example 2 | (BA/4-HBA) | | 4.5 parts | | |
| Comparative | A3/70 parts | A4/30 parts | Compound 1/ | Cor-L/3.0 parts | 0.1 parts |
| Example 3 | (BA/AA) | | 3.0 parts | | |
| Comparative | A3/100 parts | — | Compound 2/ | Cor-L/2.5 parts | 0.1 parts |
| Example 4 | (BA/AA) | | 3.0 parts | TAZM/0.02 parts | |

*meaning of symbols in monomer composition column of high molecular weigh acryl resin
BA: butyl acrylate, 4-HBA: 4-hydroxybutyl aerylate, 2-HEA: 2-hydroxyethyl acrylate, AA: acrylic acid

(b) Production of optical film coated with adhesive

Each of the adhesive compositions described above was coated on the separation-treated surface of a separation-treated polyethylene terephthalate film (trade name “PET 3811” obtained from Lintec Corporation; referred to as a separator) using an applicator for the thickness after drying to be 25 μm, dried at 90° C. for 1 minute, thereby to give a sheet-like adhesive. Next, on one surface of a three-layer structured polarizing film in which both surfaces of a polarizer made of polyvinyl alcohol in which iodine is adsorbed and oriented are sandwiched with protective films made of triacetyl cellulose, the sheet-like adhesive obtained above was laminated on the opposite surface of the separator (adhesive surface) by a laminator, and then cured in conditions of a temperature of 23° C. and a relative humidity of 65% for 10 days, thereby to give an optical film coated with an adhesive

### (c) Evaluation on Antistatic Property of Optical Film Coated with Adhesive

In peeling the separator of the optical film coated with an adhesive obtained, a surface resistance value of the adhesive was measured by a surface specific resistance tester (“Hirest-up MCP-HT450” ™, manufactured by Mitsubishi Chemical Co., Ltd.) to evaluate antistatic property P A good antistatic property is obtained when the surface resistance value is 10¹¹Ω/□ or less.

### (d) Production and Evaluation of Optical Laminate

The polarizing film coated with an adhesive produced in the above-described (b) was laminated so as to be crossed nicols on both surfaces of a glass substrate for a liquid crystal cell (“1737” ™, manufactured by Corning Corporation) to produce an optical laminate. When this optical laminate was subjected to a heat resistance test under a drying condition at 80° C. holding for 96 hours, an expression state of white tinge was observed by naked eye. Further, when a heat resistance test was conducted; when a heat and humidity test at a temperature of 60° C., a relative humidity of 90%, and holding for 96 hours was conducted; and when, being cooled to −20° C. from the state heated to 60° C., and subsequently being raised to 60° C. is defined as one cycle (1 hour), and a heat shock test by repeating 100 cycles was conducted. The respective optical laminates were observed by naked eye. The results were classified by the following criteria, and summarized in Table 2.

(Expression State of White Tinge)

the expression state of white tinge when light was radiated from one side of a light polarizing film was evaluated by the following 4 stages.

⊙: no white tinge observed

∘: white tinge hardly notified

Δ: white tinge somewhat observed

x: white tinge markedly observed

(Heat resistance, heat and humidity resistance and heat shock resistance (denoted as “HS resistance” in Table 2))

These evaluations were conducted by the following 4 stages.

⊙: no change in appearance such as floating, peeling and foaming observed

∘: change in appearance such as floating, peeling and foaming hardly notified

Δ: change in appearance such as floating, peeling and foaming somewhat observed

x: change in appearance such as floating, peeling and foaming markedly observed

### (e) Evaluation of Re-Workability of Optical Film Coated with Adhesive

The evaluation on re-workability of the optical film coated with an adhesive was conducted as follows. First, the polarizing film coated with an adhesive described above was cut into a test piece with a size of 25 mm by 150 mm. Next, this test piece was laminated on a glass substrate for a liquid crystal cell at the adhesive side by a laminating apparatus (“Lamipacker” ™, manufactured by Fuji Plastic Machinery K.K.), and was subjected to an auto clave treatment at 50° C., 5 kg/cm² (490.3 kPa) for 20 minutes. Next, it was heat-treated at 70° C. for 2 hours, subsequently held in an oven at 50° C. for 48 hours, then in an atmosphere of 23° C. and 50% relative humidity, the polarizing film was peeled from this adhesion test piece in a direction of 180° at a speed of 300 mm/min, the condition of the glass plate surface was observed, and evaluated by the following criteria. The results are collectively shown in Table 2.

TABLE 2

| | Monomer | | Surface | | | Heat and | | |
|---|---|---|---|---|---|---|---|---|
| | composition | Ionic | resistance | White | Heat | humidlty | HS | |
| | of resin* | compound | value | tinge | resistance | resistance | resistance | Re-workability |
| Example 1 | BA/4-HBA | Compound 1 | 6.0 × 10⁹ Ω/ | ◯ | ⊙ | ⊙ | ◯ | ⊙ |
| Example 2 | BA/2-HEA/AA | Compound 1 | 2.4 × 10¹⁰ Ω/ | ◯ | ⊙ | ⊙ | ◯ | ⊙ |
| Example 3 | BA/2-HEA/AA | Compound 2 | 5.5 × 10¹⁰ Ω/ | ◯ | ⊙ | ⊙ | ⊙ | ⊙ |
| Comparative | BA/4-HBA | — | >10¹⁴ Ω/ | ◯ | ⊙ | ⊙ | ◯ | ⊙ |
| Example 1 | | | | | | | | |
| Comparative | BA/4-HBA | Compound 3 | 3.6 × 10¹⁰ Ω/ | ◯ | ⊙ | X | X | ⊙ |
| Example 2 | | | | | | | | |
| Comparative | BA/AA | Compound 1 | 7.4 × 10¹⁰ Ω/ | ⊙ | ◯ | X | ⊙ | ◯ |
| Example 3 | | | | | | | | |
| Comparative | BA/AA | Compound 2 | 2.0 × 10¹⁰ Ω/ | ⊙ | ⊙ | Δ | ⊙ | ⊙ |
| Example 4 | | | | | | | | |

*meaning of symbols in monomer composition column of resin is the same as the remark in Table 1.
⊙: no cloudiness on glass plate surface observed
◯: cloudiness on glass plate surface hardly observed
Δ: cloudiness on glass plate surface observed
X: the residue of adhesive on glass plate surface observed

As is understood from Table 1 and Table 2, Examples 1 to 3 in which the acryl resin having the structural unit derived from the hydroxyl group-containing monomer specified by the present invention is compounded with the ionic compound also specified by the present invention is excellent in antistatic property due to its low surface resistance value and hardly generates white tinge, and also, has almost satisfying results all in heat resistance, heat and humidity resistance, heat shock resistance, and re-workability.

In contrast, for Comparative Example 1 in which the ionic compound was not mixed, an antistatic property cannot be expected because of its high surface resistance value. Comparative Example 2 in which the acryl resin having a structural unit derived from the hydroxyl group-containing monomer was mixed with the compound 3 not satisfying the specification of the present invention is ionic and shows a good antistatic property, but showed insufficient results in heat and humidity resistance and heat shock resistance. Besides, Comparative Example 3 wherein a mixture of an acryl resin A3 having high-molecular weight and a carboxyl group instead of a hydroxyl group as a polar functional group and acryl resin A4 having low-molecular weight and hydroxyl group as a polar functional group was mixed with the ionic compound recited by the present invention showed a good antistatic property, but showed insufficient results in heat and humidity resistance. As shown in comparative example 4, a composition of an acryl resin 3 having high-molecular weight and a carboxyl group as a polar functional group mixed with the ionic compound was not sufficient for heat and humidity resistance.

In Example 2, even when the acryl resin composing an adhesive composition (100 parts of the acryl resin A2 obtained in Production Example 2) was changed to a mixed resin of 90 parts of the acryl resin A2 obtained in Production Example 2 with 10 parts of the acryl resin A4 obtained in Production Example 4, almost the same results are obtained.

The optical film coated with an adhesive of the present invention is provided with a high antistatic property, hardly generates white tinge even when being upsized, and has excellent durability, so that it is preferably used in a liquid crystal display device.

What is claimed is:

1. An optical film with an adhesive layer on at least one surface of the optical film:
wherein said adhesive layer is formed from a composition containing:
(A) an acryl resin comprising a first acryl resin which has a structural unit derived from (meth)acrylate expressed by the following formula (I) as a main component, and a structural unit derived from unsaturated monomer having one olefinic double bond and at least one hydroxyl group in a molecule with a weight-average molecular weight of 500,000 to 2,000,000, wherein the amount of said structural unit derived from unsaturated monomer having a hydroxyl group is 0.5 to 10 parts by weight relative to 100 parts by weight of the acryl resin; 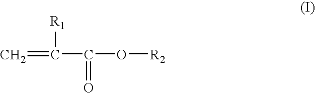
wherein R₁ represents a hydrogen atom or a methyl group, R₂ represents an alkyl group or an aralkyl group having 1-14 carbon atoms that may be substituted by an alkoxy group having 1-10 carbon atoms,
(B) an ionic compound containing a pyridinium based cation expressed by the following formula (II); 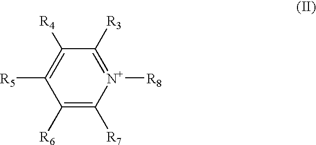
wherein at least one of R₃ through R₇ represents an alkyl group having 1-6 carbon atoms, the remainders each independently represent hydrogen or an alkyl group having 1-6 carbon atoms, R₈ represents an alkyl group having 1-12 carbon atoms; and
(C) a crosslinker.

2. The optical film according to claim 1, wherein the structural unit derived from (meth)acrylate contains a structural unit derived from a butyl acrylate.

3. The optical film according to claim 1 or 2, wherein the acryl resin (A) further contains a second acryl resin which has a structural unit derived from (meth)acrylate expressed by said formula (I) as a main component and a weight-average molecular weight of 50,000 to 300,000.

4. The optical film according to claims 1 or 2, wherein an anion of the ionic compound (B) contains a fluorine atom.

5. The optical film according to claim 4, wherein the anion is bis(trifluoromethanesulfonyl)imide or hexafluorophosphate.

6. The optical film according to claim 1 or 2, wherein an amount of the ionic compound (B) is in a ratio of 0.1 to 10 parts by weight relative to 100 parts by weight of the acryl resin (A).

7. The optical film according to claim 1 or 2, wherein the crosslinker (C) is an isocyanate based compound.

8. The optical film according to claim 7, wherein the crosslinker (C) is selected from the group consisting of tolylene diisocyanate, an aduct that polyol is reacted with tolylene diisocyanate, a dimer of tolylene diisocyanate and a trimer of tolylene diisocyanate.

9. The optical film according to claim 1, wherein the composition further contains a silane based compound.

10. The optical film according to claim 1, wherein the optical film is selected from a polarizing film and a phase retardation film.

11. An optical laminate wherein the optical film of claim 1 is laminated on a glass substrate at the adhesive layer side.
